(19) United States
(12) Patent Application Publication
(10) Pub. No.: US 2005/0031524 A1
(43) Pub. Date: Feb. 10, 2005

(54) Process for producing fullerene

(76) Inventor: Naoki Komatsu, Otsu-Shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/491,292

(22) PCT Filed: Oct. 9, 2002
(86) PCT No.: PCT/JP02/10466

(30) Foreign Application Priority Data
Oct. 11, 2001 (JP) 2001-314408
Jan. 30, 2002 (JP) 2002-21599

(51) Int. Cl. C01B 31/00

(52) U.S. Cl. 423/445 B

(57) ABSTRACT

A process for efficiently producing a target fullerene having a high purity in high yield by a simple method comprising simple steps using small amounts of a solvent and a reagent. The process for fullerene production comprises passing a solution obtained by dissolving a fullerene mixture containing a fullerene in an organic solvent through a layer of powdery activated carbon and then passing an organic solvent in which fullerene C₇₀ has a higher solubility than in that organic solvent. Thus, fullerene C₆₀ and fullerene C₇₀ can be separately obtained.

### TECHNICAL FIELD

The present invention relates to an efficient process for preparing fullerene using activated carbon.

### BACKGROUND ART

Fullerene is the generic name of fullerene C₆₀, in which 60 carbon atoms are bonded, and analogs thereof. Examples are fullerene C₆₀, which is a soccer ball-shaped molecule, and fullerene C₇₀, which is a rugby ball-shaped molecule, and as those having at most 100 carbon atoms, C₇₆, C₇₈, C₈₂, C₈₄, C₉₀ and C₉₆ are known.

Research on fullerenes is currently progressing worldwide. Applications of fullerenes to superconductors with high Tc, semiconductors, photoconductive composite materials, nonlinear optical materials, photoconductive materials, molecular ferromagnetic materials, solid lubricants and physiologically active substances have been reported, but are not yet realized. The greatest factor for this is said to lie in cost of fullerenes and low-cost process for mass-production of fullerenes with high purity is strongly desired so that fullerenes can be widely used in society.

The above fullerenes are obtained by producing soot from raw material such as graphite or hydrocarbon by laser ablation, arc discharge or combustion and then purifying fullerene mixture extracted from the soot. As methods for purifying fullerene C₆₀, known are column chromatography, recrystallization, sublimation, extraction with supercritical fluid, selective inclusion and precipitation with calixarene and a method utilizing solubility difference. However, although fullerene C₆₀ with high purity can be obtained, column chromatography, the method most commonly used at present, requires a large amount of both mobile and stationary phases and is time-consuming and also, there is the problem that the amount that can be purified in one run is limited.

In order to solve these problems, selective inclusion and precipitation with calixarene (JP-A-7-237911) and a method utilizing solubility difference (JP-A-7-10512) have been developed. According to these methods, although a relatively large amount can be purified in one run, complicated operation, such as repeating heating, stirring for a long time and filtration several times, is necessary in order to obtain fullerenes with high purity of at least 99%, and furthermore, yield is not very high. Also, C₇₀ with high purity cannot be obtained by either method.

On the other hand, as a purification process for easily mass-producing fullerene C₆₀ with high purity, JP-A-5-85711 discloses the method of extracting soot containing fullerene C₆₀ with an organic solvent such as toluene, adding powdered activated carbon to the extracted solution, stirring the mixture, separating and evaporating toluene to obtain a purified substance. Specifically, the above method is the method of purifying C₆₀ by adding activated carbon into an organic solution in which soot is dissolved, stirring the obtained suspension while heating at 70° C. for 15 minutes to 2 hours, separating solid and liquid and then concentrating the filtrate. The form and particle size of activated carbon used herein is not particularly limited. In this method, contacting with activated carbon is troublesome and requires time and, furthermore, yield is not very high. Also, purity is not mentioned. In Example 1, yield of fullerene C₆₀, which is obtained by dispersing 20 g of powdered activated carbon in a toluene solution, in which 5 g of soot containing fullerene C₆₀ is dissolved, and conducting operations such as filtration after heating and stirring at 70° C. for 15 minutes, was 260 mg. When considering that soot produced by arc discharge contains about 10% of C₆₀, the yield is considered to be about 50%. Also, the amount of powdered activated carbon that is used is about 40 times the amount of fullerene C₆₀ contained in soot and an extremely large amount of activated carbon is necessary. Example 2 describes that when the same operation was conducted using 5 g of powdered activated carbon and stirring for 2 hours, 160 mg of fullerene C₆₀ was obtained. In the same way, the yield is presumed to be about 30%. By reducing the amount of activated carbon and increasing the stirring time, the yield is significantly decreased. The reason therefor is not clear. However, according to this method, an extremely large amount of powdered activated carbon based on fullerene C₆₀ is necessary and when the amount of powdered activated carbon is reduced, the treatment time becomes longer and yield decreases. Furthermore, the method of passing fullerenes using activated carbon as a stationary phase is suggested, but the conditions thereof are not disclosed.

The present invention solves the above problems and relates to a process for efficiently preparing fullerenes with high purity in high yields by facile process and operation, and also a small amount of a solvent and a reagent.

### DISCLOSURE OF INVENTION

That is, the present invention relates to a process for preparing fullerene, which comprises passing a solution of a fullerene mixture through a layer of powdered activated carbon.

The fullerene is preferably fullerene C₆₀.

The layer of powdered activated carbon is preferably washed with an organic solvent.

The fullerene is preferably fullerene C₇₀ and an organic solvent having higher solubility of fullerene C₇₀ than the above organic solvent is preferably passed through the layer of powdered activated carbon, through which the solution is passed.

The organic solvent is preferably xylene.

The powdered activated carbon preferably has a particle size of at most 50 mesh.

The amount of the powdered activated carbon is preferably 50 to 5000% by weight based on the fullerene mixture.

The thickness of the layer of powdered activated carbon is preferably 1 to 150 mm.

The flow rate of the solvent per unit area of the layer of activated carbon is preferably 1.0 to 20 ml/minute·cm².

### BEST MODE FOR CARRYING OUT THE INVENTION

In the process of the present invention, passing through a filter cake of powdered activated carbon refers to conducting the step of filtering a fullerene solution, previously obtained by dissolving a fullerene mixture containing fullerenes in an organic solvent, by a filter layer on which powdered activated carbon is placed. Also, the step of passing an organic solvent through the filter cake can be included. Thereafter, fullerene is prepared by conducting the step of removing the organic solvent from the obtained filtrate.

The fullerene mixture used in the present invention can be a substance containing fullerene C₆₀, fullerene C₆₀ and fullerene C₇₀, or derivatives and analogs thereof and the method for preparing the fullerene mixture is not particularly limited. An example is soot produced from raw material such as graphite and hydrocarbon by laser ablation, arc discharge or combustion. The fullerene mixture can also be the extracted solution, which is obtained by extracting crude fullerene from soot by an organic solvent, or a substance commercially available as, for example, powder of raw fullerene soot. Also, a mixture having high fullerene C₆₀ content (70 to 75%) or relatively low content (60 to 65%) can be used, as fullerene C₆₀ can be sufficiently separated according to the present invention. Soot contains substances that are insoluble in an organic solvent and when soot is added to an organic solvent, a suspension is formed. This suspension can also be used as the solution used in the present invention. Furthermore, the process of the present invention can also be used for preparing endohedral metallofullerenes and heterofullerenes.

The raw material of the powdered activated carbon used in the present invention is not particularly limited and examples are wood, sawdust, palm kernel, lignin, cow bone, blood, lignite, brown coal, peat and coal. These are carbonized and then activated to obtain powdered activated carbon. The method for activating is not particularly limited and examples are chemical and steam activation. Of these, coal chemically activated with zinc chloride is preferable, as the coal is considered to have large pore volume, large pore diameter and large specific surface area. Also, using activated carbon in the form of powder is one of the features in the present invention. When the activated carbon is in a form other than powder, such as particle, granulate or fiber, fullerenes having 70 and more carbon atoms are not properly retained by the activated carbon and poorly separated from fullerene C₆₀. The particle size of the powdered activated carbon is preferably at most 50 mesh by an ASTM sieve, that is smaller than about 300 μm. When the particle size of activated carbon is more than 50 mesh (about 300 μm), retention of fullerenes of C₇₀ and more is weak, separation becomes poor and purity of fullerene C₆₀ tends to decrease. The particle size is more preferably 50 to 400 mesh (about 300 to 40 μm), particularly preferably 100 to 400 mesh (about 150 to 40 μm), further preferably 100 to 330 mesh (about 150 to 50 μm), most preferably 100 to 200 mesh (about 150 to 74 μm). When the particle size is smaller than 400 mesh (about 40 μm), retention of not only fullerene C₇₀ but also fullerene C₆₀ becomes strong, yield of fullerene C₆₀ decreases and separation tends to take a long time. Also, the average particle size is preferably 5 to 100 μm, more preferably 20 to 70 μm. The activated carbon can be used alone or at least two types of different particle size, preparation process or raw material can be used in combination. The powdered activated carbon can also be used in combination with a substance having molecular sieving ability or molecular adsorption ability such as adsorption resin, chelate resin, silica gel, alumina and molecular sieves. The pore diameter in the activated carbon is preferably 0.5 to 30 nm, more preferably 1 to 10 nm, particularly preferably 2.5 to 5 nm. When the average pore diameter is less than 0.5 nm, fullerenes of C₇₀ and more are hard to be adsorbed in the activated carbon and purity of fullerene C₆₀ tends to decrease. When the average pore diameter is more than 30 nm, discrimination to fullerene C₆₀ decreases and purity of fullerene C₆₀ tends to decrease. The activated carbon is more preferable the larger the specific surface area is, from the viewpoint that the amount of the activated carbon can be small. The specific surface area is preferably 500 to 4000 m²/g, from the viewpoints that fullerenes having 70 and more carbon atoms and other impurities can be properly retained to the activated carbon.

The layer of powdered activated carbon used in the present invention is obtained, for example, by placing powdered activated carbon on filter paper. An example of the method therefor is the method of suspending the powdered activated carbon in an organic solvent and filtering the suspension with suction using a funnel, on which filter paper is laid, to evenly place the activated carbon on the filter paper. Besides suction, activated carbon can be evenly placed under pressure or under atmospheric pressure. Also, a layer of powdered activated carbon of various forms can be used, such as activated carbon paper in the form of a sheet or a pleat and powdered activated carbon molded into a honeycomb shape, a block or a cylinder. The powdered activated carbon is preferably placed in an amount of 50 to 5000% by weight, more preferably 400 to 1200% by weight, based on the fullerene mixture to be filtered. When the amount of activated carbon is less than 50% by weight, separation of fullerenes becomes poor and purity of fullerene C₆₀ tends to decrease. When the amount is more than 5000%, yield of fullerene C₆₀ tends to decrease or a large amount of solvent tends to become necessary.

The thickness of the layer of powdered activated carbon is preferably 1 to 150 mm, more preferably 2 to 50 mm, further preferably 3 to 30 mm. When the layer is thinner than 1 mm, separating ability tends to become poor and when the layer is thicker than 150 mm, filtration tends to take time.

Examples of the organic solvent that dissolves the fullerene mixture are benzene, toluene, xylene, trimethylbenzene, chlorobenzene, dichlorobenzene, trichlorobenzene, bromobenzene, dibromobenzene, anisole, carbon disulfide, trichloroethylene, tetrachloroethylene and tetrachloroethane. These can be used alone or in a combination of two or more kinds. Of these, toluene is preferable in that cost is low, the boiling point is not very high and fullerenes are suitably dissolved.

The concentration of the obtained fullerene solution depends on the solvent that is used. For example, in the case of a toluene solution, the concentration is preferably 1 to 5 g/l. When the concentration of the solution is less than 1 g/l or more than 5 g/l, separation from fullerenes of C₇₀ and more tends to become poor.

By filtering the fullerene solution using the layer of powdered activated carbon, impurities other than fullerenes and fullerenes of C₇₀ and more that are contained in the fullerene mixture before filtration are adsorbed by the activated carbon and fullerene C₆₀ with high purity is contained in the filtrate. In order to increase the yield of fullerene C₆₀, an organic solvent capable of dissolving fullerene C₆₀ is preferably additionally passed through the layer of powdered activated carbon.

The flow rate (ml/minute·cm²) of the solvent per unit area (1 square centimeter) is preferably 1.0 to 20 ml/minute·cm², more preferably 1.5 to 10 ml/minute·cm². When the rate is slower than 1.0 ml/minute·cm², filtration takes a long time and when the rate is faster than 20 ml/minute·cm², separating ability tends to become poor.

Furthermore, by successively using an organic solvent having higher solubility of fullerene C₇₀ than the above organic solvent, for example, in the case of fullerene C₆₀ and fullerene C₇₀ are contained in the fullerene mixture, both can be isolated to obtain fullerene C₆₀ and fullerene C₇₀ with high purity.

Examples of the organic solvent that is additionally passed through the layer of powdered activated carbon in order to obtain fullerene C₆₀ in a high yield are toluene, benzene, trichloroethylene and tetrachloroethylene. Of these, toluene is preferable in that cost is low, the boiling point is not very high and fullerenes are suitably dissolved.

Examples of the organic solvent having higher solubility of fullerene C₇₀ than the above organic solvent that is passed through to obtain fullerene C₇₀ are xylene, trimethylbenzene, bromobenzene, dibromobenzene, anisole, chlorobenzene, dichlorobenzene, trichlorobenzene, carbon disulfide and tetrachloroethane. An organic solvent having solubility of fullerene C₇₀ of more than 5.0 g/l at room temperature is preferable. Of these, from the viewpoint that fullerenes are easily dissolved, o-dichlorobenzene and xylene (o-xylene, m-xylene, p-xylene or mixtures thereof) are preferable. The solubility of fullerene C₇₀ to o-dichlorobenzene and o-xylene are 36.2 g/l and 13.6 g/l respectively. o-Xylene is most preferable from the viewpoints that o-xylene exhibits suitable solubility to fullerenes and can be easily evaporated using a rotary evaporator in the same manner as toluene.

For example, in the filtrate obtained by filtering a fullerene mixture containing fullerene C₆₀ and fullerene C₇₀ dissolved in toluene by the layer of powdered activated carbon and then passing toluene through, fullerene C₆₀ with high purity is contained. Then, by evaporating toluene, fullerene C₆₀ is obtained in a high yield. Herein, the value (1/g) obtained by dividing the volume of filtrate containing fullerene C₆₀ (1) by the amount of the fullerene mixture (g) is a standard of the amount of toluene that is necessary for obtaining fullerene C₆₀ and the value is preferably 0.3 to 2.0, more preferably 0.5 to 1.6. When the value is less than 0.3, yield of fullerene C₆₀ is low and when the value is more than 2.0, concentration takes a long time.

Subsequently, by passing toluene through the layer of powdered activated carbon, a solution of fullerene C₆₀/fullerene C₇₀=3/7 to 2/8 is obtained. Herein, the value (1/g) obtained by dividing the volume of filtrate (1) by the amount of the fullerene mixture (g) is preferably 0.7 to 1.5, more preferably 0.9 to 1.3. When the value is less than 0.7, the purity of fullerene C₇₀ obtained in a later fraction tends to become low and when the value is more than 1.5, yield of fullerene C₇₀ tends to become low.

Subsequently, by pouring o-xylene, fullerene C₇₀ can be obtained with high purity of 95% and more in a good yield. Herein, the value (1/g) obtained by dividing the volume of filtrate (1) by the amount of the fullerene mixture (g) is preferably 0.5 to 2.5, more preferably 1.0 to 1.7. When the value is less than 0.5, yield of fullerene C₇₀ tends to become low and when the value is more than 1.5, concentration takes a long time.

The process described below can be used as a specific process for preparing fullerene. First, a toluene solution of a fullerene mixture is passed through a layer containing powdered activated carbon. Then, by passing toluene through the layer, a toluene solution of almost completely pure fullerene C₆₀ is obtained. By passing toluene through the above layer once more, a mixture of fullerene C₆₀ and fullerene C₇₀ is obtained. The ratio of fullerene C₆₀ and fullerene C₇₀ in the toluene solution is 3/7 to 2/8. Subsequently, by passing o-xylene through the layer of activated carbon, fullerene C₇₀ can be obtained with high purity of 95% and more in a good yield.

Another feature of the present invention is that the process of the present invention employs the extremely simple process of passing a fullerene solution, obtained by dissolving a fullerene mixture in an organic solvent, through a layer containing powdered activated carbon. Fullerenes with high purity can be obtained in a high yield by evaporating the solvent of the filtrate. That is, the process of the present invention can be applied to mass production, as the preparation process is extremely simplified and treatment is simple.

In this way, the process of the present invention can efficiently mass-produce fullerenes with high purity in a short period of time, by the extremely simple process of merely passing a fullerene mixture solution through a layer of powdered activated carbon, together with an organic solvent.

### EXAMPLE 1

About 150 ml of toluene was added to 12.0 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a funnel having a 6.0 cm diameter (made by Kiriyama Glass Works Co.), on which a filter paper (No. 704 available from Nippon Rikagaku Kikai Co., Ltd.) was placed, to obtain a filter cake (thickness 15 mm) comprising powdered activated carbon evenly spread all over the filter paper. 1.50 g of a fullerene mixture (containing 75% of fullerene C₆₀ and 21% of fullerene C₇₀ available from Honjo Chemical Corporation) was dissolved in 750 ml of toluene and the solution was filtered with suction through the above filter cake. When purple-colored solution started to elute, suction was stopped and the filtrate was removed. Then, suction filtration was restarted and toluene and the removed filtrate were passed through the filter cake again to obtain a purple-colored filtrate (1500 ml). The amount of toluene passed through in 1 minute per unit area was 2.2 ml/minute·cm² and the time required for filtration was 24 minutes. From this filtrate, toluene was evaporated using a rotary evaporator and the residue was dried in vacuo to obtain 1.07 g of fullerene C₆₀ (purity 99%, yield 95%). Identification of fullerene C₆₀ and determination of purity were conducted by HPLC. The results are shown in Table 1. The recovered toluene was reused without purification.

### EXAMPLE 2

The purple-colored filtrate (1800 ml) was obtained in the same manner as in Example 1, except that the amount of powdered activated carbon was 15.1 g and the thickness of the activated carbon layer was 18 mm. The amount of toluene passed through in 1 minute per unit area was 2.1 ml/minute·cm² and the time required for filtration was 30 minutes. 1.06 g of fullerene C₆₀ (purity 99%, yield 94%) was obtained from this filtrate in the same manner as in Example 1. Identification of fullerene C₆₀ and determination of purity were conducted by HPLC. The results are shown in Table 1.

### EXAMPLE 3

The purple-colored filtrate (1800 ml) was obtained in the same manner as in Example 1, except that 15.0 g of powdered activated carbon (Shirasagi P, 100 mesh, average particle size 52 μm, average pore diameter 2.4 nm, specific surface area 1020 m²/g) available from Takeda Chemical Industries, Ltd. was used and the thickness of the activated carbon layer was 16 mm. The amount of toluene passed through in 1 minute per unit area was 2.1 ml/minute·cm² and the time required for filtration was 30 minutes. 0.95 g of fullerene C₆₀ (purity 99%, yield 84%) was obtained from this filtrate in the same manner as in Example 1. Identification of fullerene C₆₀ and determination of purity were conducted by HPLC. The results are shown in Table 1.

### EXAMPLE 4

About 30 ml of toluene was added to 5.0 g of powdered activated carbon (Darco G-60, 100 mesh, specific surface area 600 m²/g) available from American Norit Co. and the mixture was thoroughly mixed to obtain a suspension of activated carbon. The suspension was filtered with suction using a funnel having a 4.0 cm diameter (made by Kiriyama Glass Works Co.), on which a filter paper (No. 5C available from Kiriyama Glass Works Co.) was placed, to obtain a filter cake (thickness 10 mm) comprising powdered activated carbon evenly spread all over the filter paper. 0.50 g of a fullerene mixture (containing 70% of fullerene C₆₀ and 24% of fullerene C₇₀ available from Tokyo Kasei Kogyo Co., Ltd.) was dissolved in 250 ml of toluene and the solution was filtered with suction through the above filter cake. Subsequently, 400 ml of toluene was passed through to obtain a purple-colored filtrate (650 ml). The amount of toluene passed through in 1 minute per unit area was 2.6 ml/minute·cm² and the time required for filtration was 20 minutes. From this filtrate, toluene was evaporated using a rotary evaporator and the residue was dried in vacuo to obtain 0.34 g of fullerene C₆₀ (purity 99%, yield 97%). Then, after the previous toluene, 100 ml of a mixed solution of toluene/o-dichlorobenzene=1/1 was passed through the filter cake under reduced pressure and subsequently 200 ml of o-dichlorobenzene (solubility of fullerene C₇₀ at room temperature 36.2 g/l (A. V. Eletskii, High Temperature, 34, 2, 303-318 (1996)) was passed through to obtain a reddish brown colored filtrate. From this filtrate, o-dichlorobenzene was evaporated by distillation under reduced pressure and the residue was dried in vacuo to obtain 0.072 g of fullerene C₇₀ (purity 95%, yield 60%). Identification of fullerene C₆₀ and fullerene C₇₀ and determination of purity were conducted by HPLC. The results are shown in Table 1. The recovered toluene and o-dichlorobenzene were reused without purification.

### EXAMPLE 5

About 80 ml of toluene was added to 18.0 g of powdered activated carbon (Darco G-60, 100 mesh, specific surface area 600 m²/g) available from American Norit Co. and the mixture was thoroughly mixed to obtain a suspension of activated carbon. The suspension was filtered with suction using a funnel having a 6.0 cm diameter (made by Kiriyama Glass Works Co.), on which a filter paper (No. 704 available from Nippon Rikagaku Kikai Co., Ltd.) was placed, to obtain a filter cake (thickness 15 mm) comprising powdered activated carbon evenly spread all over the filter paper. 1.50 g of a fullerene mixture (containing 75% of fullerene C₆₀ and 21% of fullerene C₇₀ available from Honjo Chemical Corporation) was dissolved in 750 ml of toluene and the solution was filtered with suction through the above filter cake. Subsequently, 1450 ml of toluene was passed through to obtain a purple-colored filtrate (2200 ml). The amount of toluene passed through in 1 minute per unit area was 2.6 ml/minute·cm² and the time required for filtration was 30 minutes. From this filtrate, toluene was evaporated using a rotary evaporator and the residue was dried in vacuo to obtain 1.08 g of fullerene C₆₀ (purity 99%, yield 96%). Then, after the previous toluene, 300 ml of a mixed solution of toluene/o-dichlorobenzene=1/1 was passed through the filter cake under reduced pressure and subsequently 1000 ml of o-dichlorobenzene was passed through to obtain a reddish brown colored filtrate. From this filtrate, o-dichlorobenzene was evaporated by distillation under reduced pressure and the residue was dried in vacuo to obtain 0.19 g of fullerene C₇₀ (purity 90%, yield 62%). Identification of fullerene C₆₀ and fullerene C₇₀ and determination of purity were conducted by HPLC. The results are shown in Table 1.

### EXAMPLE 6

The purple-colored filtrate (1800 ml) was obtained in the same manner as in Example 5, except that the amount of toluene passed subsequently was 1050 ml. The amount of toluene passed through in 1 minute per unit area was 2.6 ml/minute·cm² and the time required for filtration was 25 minutes. 1.04 g of fullerene C₆₀ (purity 99%, yield 92%) was obtained from this filtrate in the same manner as in Example 5. Identification of fullerene C₆₀ and determination of purity were conducted by HPLC. The results are shown in Table 1.

### EXAMPLE 7

About 80 ml of toluene was added to 15.0 g of powdered activated carbon (Darco G-60, 100 mesh, specific surface area 600 m²/g) available from American Norit Co. and the mixture was thoroughly mixed to obtain a suspension of activated carbon. The suspension was filtered with suction using a funnel having a 6.0 cm diameter (made by Kiriyama Glass Works Co.), on which a filter paper (No. 704 available from Nippon Rikagaku Kikai Co., Ltd.) was placed, to obtain a filter cake (thickness 13 mm) comprising powdered activated carbon evenly spread all over the filter paper. 1.50 g of a fullerene mixture (containing 75% of fullerene C₆₀ and 21% of fullerene C₇₀ available from Honjo Chemical Corporation) was dissolved in 750 ml of toluene and the solution was filtered with suction through the above filter cake. Subsequently, 1250 ml of toluene was passed through to obtain a purple-colored filtrate (2000 ml). The amount of toluene passed through in 1 minute per unit area was 2.8 ml/minute·cm² and the time required for filtration was 25 minutes. From this filtrate, toluene was evaporated using a rotary evaporator and the residue was dried in vacuo to obtain 0.97 g of fullerene C₆₀ (purity 99%, yield 86%). Then, after the previous toluene, 800 ml of chlorobenzene was passed through the filter cake under reduced pressure and subsequently 1000 ml of o-dichlorobenzene was passed through to obtain a reddish brown colored filtrate. From this filtrate, o-dichlorobenzene was evaporated by distillation under reduced pressure and the residue was dried in vacuo to obtain 0.18 g of fullerene C₇₀ (purity 90%, yield 55%). Identification of fullerene C₆₀, identification of fullerene C₇₀ and determination of purity were conducted by HPLC. The results are shown in Table 1. The recovered toluene was reused without purification.

### EXAMPLE 8

The purple-colored filtrate (850 ml) was obtained in the same manner as in Example 5, except that 13.0 g of powdered activated carbon (PW-P, 100 mesh) available from Kuraray Chemical Co., Ltd. was used and the thickness of the activated carbon layer was 9 mm. The amount of toluene passed through in 1 minute per unit area was 3.0 ml/minute·cm² and the time required for filtration was 10 minutes. 0.97 g of fullerene C₆₀ (purity 96%, yield 86%) was obtained from this filtrate in the same manner as in Example 5. Identification of fullerene C₆₀ and determination of purity were conducted by HPLC. The results are shown in Table 1.

### EXAMPLE 9

About 30 ml of toluene was added to 5.1 g of powdered activated carbon (No. 102186, 150 mesh, average particle size 30 μm) available from Merck & Co., Inc. and the mixture was thoroughly mixed to obtain a suspension of activated carbon. The suspension was filtered with suction using a funnel having a 4.0 cm diameter (made by Kiriyama Glass Works Co.), on which a filter paper (No. 5C available from Kiriyama Glass Works Co.) was placed, to obtain a filter cake (thickness 10 mm) comprising powdered activated carbon evenly spread all over the filter paper. 0.48 g of a fullerene mixture (containing 73% of fullerene C₆₀ and 24% of fullerene C₇₀ available from Tokyo Kasei Kogyo Co., Ltd.) was dissolved in 300 ml of toluene and the solution was filtered with suction through the above filter cake. Subsequently, 130 ml of toluene was passed through to obtain a purple-colored filtrate (430 ml). The amount of toluene passed through in 1 minute per unit area was 2.9 ml/minute·cm² and the time required for filtration was 12 minutes. From this filtrate, toluene was evaporated using a rotary evaporator and the residue was dried in vacuo to obtain 0.32 g of fullerene C₆₀ (purity 99%, yield 91%). Identification of fullerene C₆₀ and determination of purity were conducted by HPLC. The results are shown in Table 1.

### EXAMPLE 10

About 30 ml of toluene was added to 5.6 g of powdered activated carbon (No. 102186, 150 mesh, average particle size 30 μm) available from Merck & Co., Inc. and the mixture was thoroughly mixed to obtain a suspension of activated carbon. The suspension was filtered with suction using a funnel having a 4.0 cm diameter (made by Kiriyama Glass Works Co.), on which a filter paper (No. 5C available from Kiriyama Glass Works Co.) was placed, to obtain a filter cake (thickness 11 mm) comprising powdered activated carbon evenly spread all over the filter paper. 0.55 g of a fullerene mixture (containing 73% of fullerene C₆₀ and 24% of fullerene C₇₀ available from Tokyo Kasei Kogyo Co., Ltd.) was dissolved in 250 ml of toluene and the solution was filtered with suction through the above filter cake. Subsequently, 160 ml of toluene was passed through to obtain a purple-colored filtrate (410 ml). The amount of toluene passed through in 1 minute per unit area was 2.7 ml/minute·cm² and the time required for filtration was 12 minutes. From this filtrate, toluene was evaporated using a rotary evaporator and the residue was dried in vacuo to obtain 0.37 g of fullerene C₆₀ (purity 99%, yield 92%). Identification of fullerene C₆₀ and determination of purity were conducted by HPLC. The results are shown in Table 1.

### EXAMPLE 11

About 50 ml of toluene was added to 1.2 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a funnel having a 2.1 cm diameter (made by Kiriyama Glass Works Co.), on which a filter paper (No. 5C available from Kiriyama Glass Works Co.) was placed, to obtain a filter cake (thickness 10 mm) comprising powdered activated carbon evenly spread all over the filter paper. 148 mg of a fullerene mixture (containing 59% of fullerene C₆₀ and 31% of fullerene C₇₀ available from MTR Ltd.) was dissolved in 50 ml of toluene and the solution was filtered under reduced pressure by the above filter cake. When purple-colored solution started to elute, suction was stopped and the filtrate was removed. Then, suction filtration was restarted and subsequent to the toluene solution of the fullerene mixture, toluene containing the removed filtrate was passed through the filter cake again until reddish components started flowing out to obtain a purple-colored filtrate (about 100 ml). The amount of toluene passed through in 1 minute per unit area was 6.4 ml/minute·cm² and the time required for filtration was 5 minutes. From this filtrate, toluene was evaporated using a rotary evaporator and the residue was dried in vacuo to obtain 75.7 mg of fullerene C₆₀ (purity 99%, yield 87%).

Subsequently, 50 ml of toluene was poured. Then, toluene was evaporated from the filtrate using a rotary evaporator and the residue was dried in vacuo to obtain 12.3 mg of a mixture of fullerene C₆₀ and fullerene C₇₀ (fullerene C₆₀/fullerene C₇₀=63/37). The ratio of fullerene C₆₀ and fullerene C₇₀ was approximately the same as that of the fullerene mixture before filtration and so the mixture can be returned to the fullerene mixture before filtration and used again for purification.

Thereafter, 200 ml of o-xylene was passed through the filter cake and a filtrate was obtained. o-Xylene was evaporated from this filtrate using a rotary evaporator and the residue was dried in vacuo to obtain 47.0 mg of fullerene C₇₀ (purity 88%).

The following filtration was conducted in order to increase the purity of the fullerene C₇₀.

About 50 ml of toluene was added to 1.2 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a funnel having a 2.1 cm diameter (made by Kiriyama Glass Works Co.), on which a filter paper (No. 5C available from Kiriyama Glass Works Co.) was placed, to obtain a filter cake (thickness 10 mm) comprising powdered activated carbon evenly spread all over the filter paper. 47.0 mg of the fullerene C₇₀ having purity of 88% obtained above was dissolved in 25 ml of toluene and the solution was filtered under reduced pressure by the above filter cake. Subsequently, 175 ml of toluene was poured. After the receptacle was exchanged, 150 ml of o-xylene was passed through and a filtrate was obtained. This filtrate was concentrated and dried in vacuo to obtain 21.5 mg of fullerene C₇₀ (97%) at yield of 47% based on the fullerene C₇₀ in the original fullerene mixture. Identification of fullerene C₆₀, identification of fullerene C₇₀ and determination of purity were conducted by HPLC. The results are shown in Table 1.

### EXAMPLE 12

71.1 mg of fullerene C₆₀ (purity 99%, yield 77%) was obtained in the same manner as in Example 11, except that 149 mg of a fullerene mixture (containing 62% of fullerene C₆₀ and 30% of fullerene C₇₀ available from MTR Ltd.) was used. The amount of toluene passed through in 1 minute per unit area was 6.4 ml/minute·cm² and the time required for filtration was 5 minutes.

Subsequently, 50 ml of toluene was poured. 9.6 mg of a mixture of fullerene C₆₀ and fullerene C₇₀ (fullerene C₆₀/fullerene C₇₀=66/34) was obtained from this filtrate in the same manner as in Example 11. The ratio of fullerene C₆₀ and fullerene C₇₀ was approximately the same as that of the fullerene mixture before filtration and so the mixture can be returned to the fullerene mixture before filtration and used again for purification.

Thereafter, 200 ml of o-xylene was passed through the filter cake and 50.3 mg of fullerene C₇₀ (purity 88%) was obtained in the same manner as in Example 11.

In the same manner as in Example 11, in order to increase the purity of the fullerene C₇₀, 50.3 mg of the fullerene C₇₀ having purity of 88% obtained above was dissolved in 25 ml of toluene and the solution was filtered under reduced pressure by the filter cake on which 0.51 g of activated carbon was spread. Subsequently, 50 ml of toluene was passed through. After the receptacle was exchanged, 100 ml of O-xylene was passed through and a filtrate was obtained. This filtrate was concentrated and dried in vacuo to obtain 20.9 mg of fullerene C₇₀ (purity 98%) at yield of 46% based on the fullerene C₇₀ in the original fullerene mixture. Identification of fullerene C₆₀, identification of fullerene C₇₀ and determination of purity were conducted by HPLC. The results are shown in Table 1.

### EXAMPLE 13

76.5 mg of fullerene C₆₀ (purity 99%, yield 86%) was obtained in the same manner as in Example 11, except that 1.2 g of powdered activated carbon (Taiko S, 100 mesh, average particle size 35 μm, specific surface area 1250 m²/g) available from Futamura Chemical Industries Co., Ltd. was used as the powdered activated carbon, the thickness of the activated carbon layer was 10 mm and 151 mg of a fullerene mixture was used. The amount of toluene passed through in 1 minute per unit area was 6.8 ml/minute·cm² and the time required for filtration was 7 minutes.

Subsequently, 50 ml of toluene was poured. 8.0 mg of a mixture of fullerene C₆₀ and fullerene C₇₀ (fullerene C₆₀/fullerene C₇₀=81/19) was obtained from this filtrate in the same manner as in Example 11. The ratio of fullerene C₆₀ and fullerene C₇₀ was approximately the same as that of the fullerene mixture before filtration and so the mixture can be returned to the fullerene mixture before filtration and used again for purification.

Thereafter, 200 ml of o-xylene was passed through the filter cake and 46.8 mg of fullerene C₇₀ (purity 91%, yield 91%) was obtained in the same manner as in Example 11.

Identification of fullerene C₆₀, identification of fullerene C₇₀ and determination of purity were conducted by HPLC. The results are shown in Table 1.

### EXAMPLE 14

82.6 mg of fullerene C₆₀ (purity 99%, yield 85%) was obtained in the same manner as in Example 11, except that 1.2 g of powdered activated carbon (Taiko FC, 100 mesh, average particle size 45 μm, specific surface area 1250 m²/g) available from Futamura Chemical Industries Co., Ltd. was used as the powdered activated carbon, the thickness of the activated carbon layer was 12 mm and 151 mg of a fullerene mixture (containing 64% of fullerene C₆₀ and 28% of fullerene C₇₀ available from MTR Ltd.) was used. The amount of toluene passed through in 1 minute per unit area was 7.4 ml/minute·cm² and the time required for filtration was 6 minutes.

Subsequently, 50 ml of toluene was poured. 10.7 mg of a mixture of fullerene C₆₀ and fullerene C₇₀ (fullerene C₆₀/fullerene C₇₀=91/9) was obtained from this filtrate in the same manner as in Example 11.

Thereafter, 200 ml of o-xylene was passed through the filter cake and 41.2 mg of fullerene C₇₀ (purity 83%, yield 80%) was obtained in the same manner as in Example 11.

Identification of fullerene C₆₀, identification of fullerene C₇₀ and determination of purity were conducted by HPLC. The results are shown in Table 1.

### EXAMPLE 15

83.0 mg of fullerene C₆₀ (purity 99%, yield 84%) was obtained in the same manner as in Example 11, except that 1.2 g of powdered activated carbon (Taiko KA, 100 mesh, average particle size 30 μm, specific surface area 1180 m²/g) available from Futamura Chemical Industries Co., Ltd. was used as the powdered activated carbon, the thickness of the activated carbon layer was 9 mm and 150 mg of a fullerene mixture (containing 61% of fullerene C₆₀ and 33% of fullerene C₇₀ available from MTR Ltd.) was used. The amount of toluene passed through in 1 minute per unit area was 7.3 ml/minute·cm² and the time required for filtration was 5 minutes.

Subsequently, 200 ml of o-xylene was passed through the filter cake and 33.5 mg of fullerene C₇₀ (purity 77%, yield 67%) was obtained in the same manner as in Example 11.

Identification of fullerene C₆₀, identification of fullerene C₇₀ and determination of purity were conducted by HPLC. The results are shown in Table 1.

### EXAMPLE 16

About 500 ml of toluene was added to 80 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a funnel having a 15 cm diameter (nutsche), on which a filter paper (No. 2 available from ADVANTEC MFS, Inc.) was placed, to obtain a filter cake (thickness 17 mm) comprising powdered activated carbon evenly spread all over the filter paper. 9.1 g of a fullerene mixture (containing 69% of fullerene C₆₀ and 26% of fullerene C₇₀ available from Honjo Chemical Corporation) was dissolved in 3000 ml of toluene and the solution was filtered under reduced pressure by the above filter cake. When purple-colored solution started to elute, suction was stopped and the filtrate (about 1700 ml) was removed. Then, suction filtration was restarted and subsequent to the toluene solution of the fullerene mixture, toluene containing the removed filtrate was passed through the filter cake again until reddish solution started to elute, to obtain a purple-colored filtrate (about 7000 ml). The amount of toluene passed through in 1 minute per unit area was 1.6 ml/minute·cm² and the time required for filtration was 25 minutes. From this filtrate, toluene was evaporated using a rotary evaporator and the residue was dried in vacuo to obtain 6.0 g of fullerene C₆₀ (purity 98%, yield 95%).

Identification of fullerene C₆₀ and determination of purity were conducted by HPLC. The results are shown in Table 1.

### EXAMPLE 17

About 300 ml of toluene was added to 27 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a funnel having a 9 cm diameter (made by Kiriyama Glass Works Co.), on which a filter paper (No. 131 available from ADVANTEC MFS, Inc.) was placed, to obtain a filter cake (thickness 13 mm) comprising powdered activated carbon evenly spread all over the filter paper. 3.0 g of a fullerene mixture (containing 65% of fullerene C₆₀ and 24% of fullerene C₇₀ available from Honjo Chemical Corporation) was dissolved in 3000 ml of toluene and the solution was filtered under reduced pressure by the above filter cake. When purple-colored solution started to elute, suction was stopped and the filtrate (about 600 ml) was removed. Then, suction filtration was restarted and subsequent to the toluene solution of the fullerene mixture, toluene containing the removed filtrate was passed through the filter cake again until reddish solution started to elute, to obtain a purple-colored filtrate (about 2200 ml). The amount of toluene passed through in 1 minute per unit area was 1.7 ml/minute·cm² and the time required for filtration was 20 minutes. From this filtrate, toluene was evaporated using a rotary evaporator and the residue was dried in vacuo to obtain 1.8 g of fullerene C₆₀ (purity 99%, yield 90%).

Identification of fullerene C₆₀ and determination of purity were conducted by HPLC. The results are shown in Table 1.

### EXAMPLE 18

About 50 ml of toluene was added to 1.5 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a funnel having a 2.1 cm diameter (made by Kiriyama Glass Works Co.), on which a filter paper (No. 5C available from Kiriyama Glass Works Co.) was placed, to obtain a filter cake (thickness 1.2 cm) comprising powdered activated carbon evenly spread all over the filter paper. 150 mg of a fullerene mixture (containing 54% of fullerene C₆₀ and 34% of fullerene C₇₀ available from Honjo Chemical Corporation) was dissolved in 50 ml of toluene and the solution was filtered under reduced pressure by the above filter cake. Subsequent to the toluene solution of the fullerene mixture, by pouring toluene at a rate of 18 ml/minute until reddish components started to elute, a purple-colored filtrate (about 190 ml) was obtained. The amount of toluene passed through in 1 minute per unit area was 5.2 ml/minute·cm² and the time required for filtration was 11 minutes. From this filtrate, toluene was evaporated using a rotary evaporator and the residue was dried in vacuo to obtain 75.5 mg of fullerene C₆₀ (purity 99%, yield 93%).

Subsequently, 150 ml of toluene was poured. Then, toluene was evaporated from the filtrate using a rotary evaporator and the residue was dried in vacuo to obtain 15.2 mg of a mixture of fullerene C₆₀ and fullerene C₇₀ (fullerene C₆₀/fullerene C₇₀=31/69).

Thereafter, 200 ml of o-xylene was passed through the filter cake and 23.7 mg of fullerene C₇₀ (purity 96%, yield 46%) was obtained by concentrating the obtained filtrate using a rotary evaporator and vacuum drying the residue. Identification of fullerene C₆₀, identification of fullerene C₇₀ and determination of purity were conducted by HPLC. The results are shown in Table 1.

### EXAMPLE 19

100 ml of toluene was added to 6.0 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a funnel having a 4.0 cm diameter (made by Kiriyama Glass Works Co.), on which a filter paper (No. 5C available from Kiriyama Glass Works Co.) was placed, to obtain a filter cake (thickness 1.4 cm) comprising powdered activated carbon evenly spread all over the filter paper. 0.60 g of a fullerene mixture (containing 54% of fullerene C₆₀ and 34% of fullerene C₇₀ available from Honjo Chemical Corporation) was dissolved in 200 ml of toluene and the solution was filtered under reduced pressure by the above filter cake. Subsequent to the toluene solution of the fullerene mixture, toluene was poured at a rate of 28 ml/minute until reddish components started to elute to obtain a purple-colored filtrate (0.801). The amount of toluene passed through in 1 minute per unit area was 2.2 ml/minute·cm² and the time required for filtration was 29 minutes. From this filtrate, toluene was evaporated using a rotary evaporator and the residue was dried in vacuo to obtain 0.28 g of fullerene C₆₀ (purity 99%, yield 88%).

Subsequently, 0.80 l of toluene was poured. Then, toluene was evaporated from the filtrate using a rotary evaporator and the residue was dried in vacuo to obtain 0.05 g of a fullerene mixture (fullerene C₆₀/fullerene C₇₀=19/81).

Thereafter, 200 ml of, 0.80 l of o-xylene was passed through the filter cake and 96.4 mg of fullerene C₇₀ (purity 96%, yield 48%) was obtained by concentrating the obtained filtrate using a rotary evaporator and vacuum drying the residue. Identification of fullerene C₆₀, identification of fullerene C₇₀ and determination of purity were conducted by HPLC. The results are shown in Table 1.

### EXAMPLE 20

About 200 ml of toluene was added to 13.5 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a funnel having a 6.0 cm diameter (made by Kiriyama Glass Works Co.), on which a filter paper (No. 704 available from Nippon Rikagaku Kikai Co., Ltd.) was placed, to obtain a filter cake (thickness 1.5 cm) comprising powdered activated carbon evenly spread all over the filter paper. 1.35 g of a fullerene mixture (containing 54% of fullerene C₆₀ and 34% of fullerene C₇₀ available from MTR Ltd.) was dissolved in 450 ml of toluene and the solution was filtered under reduced pressure by the above filter cake. Subsequent to the toluene solution of the fullerene mixture, toluene was poured at a rate of 60 ml/minute until reddish components started to elute to obtain a purple-colored filtrate (1.65 l). The amount of toluene passed through in 1 minute per unit area was 2.1 ml/minute·cm² and the time required for filtration was 27 minutes. From this filtrate, toluene was evaporated using a rotary evaporator and the residue was dried in vacuo to obtain 0.66 g of fullerene C₆₀ (purity 99%, yield 90%).

Subsequently, 1.6 l of toluene was poured. Then, toluene was evaporated from the filtrate using a rotary evaporator and the residue was dried in vacuo to obtain 0.17 g of a fullerene mixture (fullerene C₆₀/fullerene C₇₀=28/72).

Thereafter, 200 ml of, 2.0 l of o-xylene was passed through the filter cake and 0.23 g of fullerene C₇₀ (purity 95%, yield 50%) was obtained by concentrating the obtained filtrate using a rotary evaporator and vacuum drying the residue. Identification of fullerene C₆₀, identification of fullerene C₇₀ and determination of purity were conducted by HPLC. The results are shown in Table 1.

### EXAMPLE 21

150 ml of toluene was added to 15.0 g of powdered activated carbon (Tokusei Shirasagi™, 100 mesh, average particle size 56 μm, average pore diameter 3.3 nm, specific surface area 1430 m²/g) available from Takeda Chemical Industries, Ltd. and the mixture was thoroughly mixed to obtain a suspension of activated carbon. The suspension was filtered with suction using a Buchner funnel having a 7.0 cm diameter, on which a filter paper (No. 131 available from ADVANTEC MFS, Inc.) was placed, to obtain a filter cake (thickness 1.5 cm) comprising powdered activated carbon evenly spread all over the filter paper. 1.85 g of a fullerene mixture (containing 70% of fullerene C₆₀ and 23% of fullerene C₇₀ available from Honjo Chemical Corporation) was dissolved in 400 ml of toluene and the solution was filtered under reduced pressure by the above filter cake. Subsequent to a toluene solution of the fullerene mixture, toluene (about 1 l) was poured at a rate of 0.18 l/minute until reddish components started to elute, to obtain a purple-colored filtrate (about 1.4 l). The amount of toluene passed through in 1 minute per unit area was 4.7 ml/minute·cm² and the time required for filtration was only 8 minutes. From this filtrate, toluene was evaporated using a rotary evaporator and the residue was dried in vacuo to obtain 1.20 g of fullerene C₆₀ (purity 98%, yield 93%). Identification of fullerene C₆₀ and determination of purity were conducted by HPLC. The results are shown in Table 1.

### COMPARATIVE EXAMPLE 1

About 20 ml of toluene was added to 1.0 g of activated carbon (Darco, 20 to 30 mesh, specific surface area 600 m²/g) available from American Norit Co. and the mixture was thoroughly mixed to obtain a suspension of activated carbon. The suspension was filtered with suction using a funnel having a 2.1 cm diameter (made by Kiriyama Glass Works Co.), on which a filter paper (No. 5C available from Nippon Rikagaku Kikai Co., Ltd.) was placed, to obtain a filter cake (thickness 15 mm) comprising powdered activated carbon evenly spread all over the filter paper. 49.7 mg of a fullerene mixture (containing 75% of fullerene C₆₀ and 21% of fullerene C₇₀ available from Honjo Chemical Corporation) was dissolved in 25 ml of toluene and the solution was filtered with suction through the above filter cake. Subsequently, 25 ml of toluene was poured and a reddish brown colored filtrate (50 ml) was obtained. As a result of HPLC analysis, the filtrate was found to be a fullerene mixture containing 78% of fullerene C₆₀ and 22% of fullerenes of a higher order of at least fullerene C₇₀ and fullerene C₆₀ and fullerene C₇₀ could not be isolated from each other. The results are shown in Table 2.

### COMPARATIVE EXAMPLE 2

About 20 ml of toluene was added to 1.5 g of granulated activated carbon (made from palm shell, 30 to 60 mesh) available from Nacalai Tesque, Inc. and the mixture was thoroughly mixed to obtain a suspension of activated carbon. The suspension was filtered with suction using a funnel having a 2.1 cm diameter (made by Kiriyama Glass Works Co.), on which a filter paper (No. 5C available from Nippon Rikagaku Kikai Co., Ltd.) was placed, to obtain a filter cake (thickness 18 mm) comprising powdered activated carbon evenly spread all over the filter paper. 50.4 mg of a fullerene mixture (containing 73% of fullerene C₆₀ and 24% of fullerene C₇₀ available from Tokyo Kasei Kogyo Co., Ltd.) was dissolved in 25 ml of toluene and the solution was filtered with suction through the above filter cake. Subsequently, 25 ml of toluene was poured and a reddish brown colored filtrate (50 ml) was obtained. As a result of HPLC analysis, the filtrate was found to be a fullerene mixture containing 76% of fullerene C₆₀ and 20% of fullerenes of a higher order of at least fullerene C₇₀ and fullerene C₆₀ and fullerene C₇₀ could not be isolated from each other. The results are shown in Table 2.

### COMPARATIVE EXAMPLE 3

About 20 ml of toluene was added to 1.0 g of fibrous activated carbon (A-15, average pore diameter 2.1 mm, specific surface area 1670 m²/g) available from Unitika, Ltd. and the mixture was thoroughly mixed to obtain a suspension of activated carbon. The suspension was filtered with suction using a funnel having a 2.1 cm diameter (made by Kiriyama Glass Works Co.), on which a filter paper (No. 5C available from Nippon Rikagaku Kikai Co., Ltd) was placed, to obtain a filter cake (thickness 15 mm) comprising powdered activated carbon evenly spread all over the filter paper. 50.8 mg of a fullerene mixture (containing 75% of fullerene C₆₀ and 21% of fullerene C₇₀ available from Tokyo Kasei Kogyo Co., Ltd.) was dissolved in 25 ml of toluene and the solution was filtered with suction through the above filter cake. Subsequently, 25 ml of toluene was poured and a reddish brown colored filtrate (25 ml) was obtained. As a result of HPLC analysis, the filtrate was found to be a fullerene mixture containing 76% of fullerene C₆₀ and 20% of fullerenes of a higher order of at least fullerene C₇₀ and fullerene C₆₀ and fullerene C₇₀ could not be isolated from each other. The results are shown in Table 2.

TABLE 1

| | | | | Thickness | Toluene Solution of | | | |
|---|---|---|---|---|---|---|---|---|
| | Activated Carbon Used | | Diameter | of Activated | Fullerene Mixture | | Filtrate | |
| | Particle | Amount | of Funnel | Carbon Layer | Concentration | Volume | containing C₆₀ | Yield of C₆₀ |
| Ex. | Size (Mesh) | Used (g) | (cm) | (mm) | (g/l) | (ml) | (ml) | (%) |
| 1 | 100 | 12.0 | 6 | 15 | 2 | 750 | 1500 | 95 |
| 2 | 100 | 15.1 | 6 | 18 | 2 | 750 | 1800 | 94 |
| 3 | 100 | 15.0 | 6 | 16 | 2 | 750 | 1800 | 84 |
| 4 | 100 | 5.0 | 4 | 10 | 2 | 250 | 650 | 97 |
| 5 | 100 | 18.0 | 6 | 15 | 2 | 750 | 2200 | 96 |
| 6 | 100 | 18.0 | 6 | 15 | 2 | 750 | 1800 | 92 |
| 7 | 100 | 15.0 | 6 | 13 | 2 | 750 | 2000 | 86 |
| 8 | 100 | 13.0 | 6 | 9 | 2 | 750 | 850 | 86 |
| 9 | 150 | 5.1 | 4 | 10 | 1.6 | 300 | 430 | 91 |
| 10 | 150 | 5.6 | 4 | 11 | 2.2 | 250 | 410 | 92 |
| 11 | 100 | 1.2 | 2.1 | 10 | 2.96 | 50 | 100 | 87 |
| 12 | 100 | 1.2 | 2.1 | 10 | 2.98 | 50 | 100 | 77 |
| 13 | 100 | 1.2 | 2.1 | 10 | 3.02 | 50 | 150 | 86 |
| 14 | 100 | 1.2 | 2.1 | 12 | 3.04 | 50 | 140 | 85 |
| 15 | 100 | 1.2 | 2.1 | 9 | 3 | 50 | 114 | 84 |
| 16 | 100 | 80 | 15 | 17 | 3.03 | 3000 | 7000 | 95 |
| 17 | 100 | 27 | 9 | 13 | 1 | 3000 | 2200 | 90 |
| 18 | 100 | 1.5 | 2.1 | 12 | 3 | 50 | 190 | 93 |
| 19 | 100 | 6.0 | 4 | 14 | 3 | 200 | 800 | 88 |
| 20 | 100 | 13.5 | 6 | 15 | 3 | 450 | 1650 | 90 |
| 21 | 100 | 15.0 | 7 | 15 | 4.625 | 400 | 1400 | 93 |

TABLE 2

| | | | | Thickness | Toluene Solution of | | | |
|---|---|---|---|---|---|---|---|---|
| | Activated Carbon Used | | Diameter | of Activated | Fullerene Mixture | | Filtrate | |
| Com. | Particle | Amount | of Funnel | Carbon Layer | Concentration | Volume | containing C₆₀ | Yield of C₆₀ |
| Ex. | Size (Mesh) | Used (g) | (cm) | (mm) | (g/l) | (ml) | (ml) | (%) |
| 1 | 20-40 | 1.0 | 2.1 | 15 | 2 | 25 | 50 | Mixture of |
| | (Particle) | | | | | | | C₆₀ and C₇₀ |
| 2 | 30-60 | 1.5 | 2.1 | 18 | 2 | 25 | 50 | Mixture of |
| | (Particle) | | | | | | | C₆₀ and C₇₀ |
| 3 | Fiber | 1.0 | 2.1 | 15 | 2 | 25 | 25 | Mixture of |
| | | | | | | | | C₆₀ and C₇₀ |

### INDUSTRIAL APPLICABILITY

According to the present invention, fullerenes with high purity can be efficiently prepared by the extremely simple process of merely passing a fullerene compound through a layer of powdered activated carbon together with an organic solvent. Also, the present invention is suited for production at an industrial level, since a large amount of fullerenes can be treated in a short period of time.

1. A process for preparing fullerene, which comprises passing a solution of a fullerene mixture through a layer of powdered activated carbon.

2. The process of claim 1, wherein said fullerene is fullerene C₆₀.

3. The process of claim 1, which further comprises washing said layer of powdered activated carbon with an organic solvent.

4. The process of claim 1, wherein said fullerene is fullerene C₇₀; and
which further comprises passing an organic solvent having higher solubility of fullerene C₇₀ than said organic solvent through said layer of powdered activated carbon, through which said solution is passed.

5. The process of claim 4, wherein said organic solvent is xylene.

6. The process of claim 1, wherein said powdered activated carbon has a particle size of at most 50 mesh.

7. The process of claim 1, wherein the amount of said powdered activated carbon is 50 to 5000% by weight based on said fullerene mixture.

8. The process of claim 1, wherein the thickness of said layer of powdered activated carbon is 1 to 150 mm.

9. The process of claim 3, wherein the flow rate of said solvent per unit area of said layer of activated carbon is 1.0 to 20 ml/minute·cm².
